(19) United States
(12) Patent Application Publication
(10) Pub. No.: US 2008/0131563 A1
(43) Pub. Date: Jun. 5, 2008

(54) Food-compatible laser-imageable coatings

(76) Inventors: Vladek Kasperchik, Corvallis, OR (US); Susan E. Bailey, Corvallis, OR (US); Joel McKay Priddy, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/606,437

(22) Filed: Nov. 30, 2006

(51) Int. Cl. A23G 3/44; A23L 1/31; A23L 1/315; A23L 1/212; A23G 3/32; A23L 1/025

(52) U.S. Cl. 426/92; 426/103; 426/102; 426/240

(57) ABSTRACT

Edible objects and methods of forming a label on an edible object are disclosed.

### BACKGROUND

Many laser imageable coatings typically include a variety of chemical components such as dyes and acid developer. Many of these chemicals are not food-compatible and therefore, can not be used on items that are to be ingested by animals such as humans. Food compatible laser-imageable coatings are required for a variety of applications. In the pharmaceutical application laser-imaging allows for marking of individual pills. At the factory level this could be used for Lot number and production information. At the pharmacy level this could be used for patient specific dosage information. Produce marking would allow for the tracking of foods from field to table. Any deliberate or accidental contamination of food sources could quickly be tracked and sources identified from a single piece of produce. A laser-imageable coating would allow decorative marking of non-uniform edible items as the laser could be focused to follow the contour of the edible item. Therefore, there is a need in the art for food-compatible laser-imageable coatings

### SUMMARY

Briefly described, embodiments of this disclosure include edible objects and methods of forming a label on an edible object. One exemplary embodiment of the edible object, among others, includes: an edible coating layer disposed on the edible object, wherein the edible coating layer includes a sugar and at least one of amino acids, wherein upon irradiation by a laser source the sugar and amino acids react to form a brown color in the edible coating layer.

One exemplary embodiment of the method of forming a label on an edible object, among others, includes: disposing a coating layer onto the edible object, wherein the coating layer includes an edible coating layer disposed on the edible object, wherein the edible coating layer includes a sugar and at least one of amino acids, wherein upon irradiation by a laser source the sugar and amino acids react to form a particular color in the edible coating layer.

### BRIEF DESCRIPTION OF THE DRAWINGS

Many aspects of this disclosure can be better understood with reference to the following drawing. The components in the drawings are not necessarily to scale. Moreover, in the drawing, like reference numerals designate corresponding parts throughout the several views.

FIG. 1 illustrates a substrate having an embodiment of a coating layer of the present disclosure, where visible marks have been made in the coating layer.

### DETAILED DESCRIPTION

Embodiments of the present disclosure will employ, unless otherwise indicated, techniques of synthetic organic chemistry, ink chemistry, media chemistry, printing chemistry, and the like, that are within the skill of the art. Such techniques are explained fully in the literature.

In the following description, for purposes of explanation, numerous specific details are set forth in order to provide a thorough understanding of the present disclosure. It will be apparent, however, to one skilled in the art to which the present disclosure relates, that the disclosed composition and systems and methods may be practiced without these specific details. Reference in the specification to “an embodiment” means that a particular feature, structure, or characteristic described in connection with the embodiment is included in at least one embodiment.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, pressure, and the like) but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Embodiments of the disclosure include food-compatible coating layers and methods of using the food-compatible coating layers. The food-compatible coating layer includes color forming components (e.g., sugars and amino acids or peptides) and optionally a matrix material. Radiation energy can be directed image-wise at the food-compatible coating layer, and on portions of the coating layer that the radiation energy impacts, the color forming components undergo a Maillard reaction to produce images. The reaction of the color forming components produces brown nitrogenous polymers and copolymers called melanoidins.

The food-compatible coating layer of the present disclosure is advantageous because, for example, non-colored objects (e.g., pharmaceutical pills or tablets) can be labeled. In addition, embodiments of the present disclosure provide a fast non-contact printing method for labels on the surface of objects that are to be ingested. Further, the coating layer is food and bio-compatible.

The coating layer(s) can be disposed on an object that is to be ingested into an animal (e.g., humans). The object can include, but is not limited to, pills, tablets, food items (e.g., meat, poultry, fruit, baked goods, and the like. The coating layer can be disposed on the surface of the object using spin-coating, rolling, spraying, screen-printing, and the like.

To form a mark, radiation energy is directed image-wise at one or more discrete areas of the coating layer of the imaging medium. The form of radiation energy may vary depending upon the equipment available, ambient conditions, the desired result, and the like. The radiation used for the labeling can include, but is not limited to, infrared (IR) visible, ultraviolet (UV) wavelength range. In an embodiment, the radiation range is IR because many organic materials have absorbance bands in this range. The most preferable radiation range is in vicinity of emission wavelength of CO₂ laser (e.g., about 10.6 um), since the CO₂ laser is commonly used for industrial labeling purposes. The color forming components absorbs the radiation energy and a reaction of the color forming components produces brown nitrogenous polymers and copolymers called melanoidins. As a result, an image is formed or outlined on the object.

As mentioned above, the food-compatible coating layer includes color forming components. The color forming components can include, but is not limited to, sugars and amino acids, peptides, or a combination thereof. The color forming components can be uniformly dissolved and/or dispersed in a solvent (e.g., water or other bio-compatible solvents). In an embodiment, the food-compatible coating layer is disposed on the object as a solution and the solvent is evaporated from the coating layer.

The term “peptide” includes a plurality of amino acids. The amino acids can include the twenty known amino acids: Alanine (Ala, A), Arginine (Arg, R), Asparagine (Asn, N), Aspartic Acid (Asp, D), Cysteine (Cys, C), Glutamine (Gln, Q), Glutamic Acid (Glu, E), Glycine (Gly, G), Histidine (His, H), Isoleucine (Ile, I), Leucine (Leu, L), Lysine (Lys, K), Methionine (Met, M), Phenylalanine (Phe, F), Proline (Pro, P), Serine (Ser, S), Threonine (Thr, T), Tryptophan (Trp, W), Tyrosine (Tyr, Y), and Valine (Val, V). In particular, the amino acids include amino acids with free amino acid groups (—NH₂, —NHR). In an embodiment, the most preferable amino acids are lysine and glycine. In an embodiment, the peptide includes at least one amino acid with a free amino acid group. In another embodiment, the peptide includes at least one lysine or glycine.

The amino acid and/or peptides are about 1 weight percent (wt %) to 45 wt % of the coating and from about 5 wt % to 95 wt % of coating layer.

The sugar can include, but is not limited to, pentose sugars, hexose sugars, disaccharides, polysugars, and combinations thereof. The pentose sugars include, but are not limited to, ribose, xylose, ribulose, xyulose, and lyxose. The hexose sugars include, but are not limited to, glucose, fructose sorbose, altrose, gulose, galactose, and mannose. The disaccharides include, but are not limited to, lactose, sucrose, and maltose. The polysugars include, but are not limited to, starches, amylose, and amylopectin. In general, the pentose sugars react more readily than hexoses, and the hexoses react more readily than disaccharides. However, pentose sugars, hexose sugars, disaccharides, polysugars, and combinations thereof, can be used in the food-compatible coating layer.

The sugars are about 1 weight percent (wt %) to 45 wt % of the coating and from about 5 wt % to 95 wt % of coating layer.

As mentioned above, the coating layer can include, but is not limited to, water-soluble polymeric binders. The water-soluble polymeric binders can include, but are not limited to, polysaccharides (e.g., starches, pectine, agar, xantham gum, and the like), polyvinyl pyrrolidone, soluble proteins (gelatin), soluble cellulose derivatives, and the like. Some of the optional binders (e.g., polysaccharides and proteins) may also participate in Maillard reaction, and, so also be part of color-forming composition.

The water-soluble polymeric binders are about 0 weight percent (wt %) to 90 wt % of the coating.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

While embodiments of the present disclosure are described in connection with Examples 1-2 and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE 1

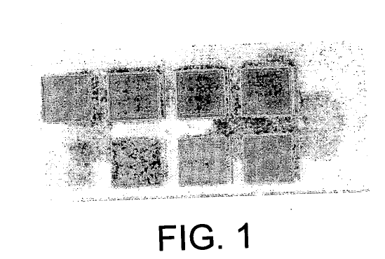

The coating was prepared by dissolution of the components (as shown in Table 1) in water. The visible marks produced on the coating are shown in FIG. 1. Table 1 shows the exemplary formulation.

TABLE 1

| | |
|---|---|
| L-Lysine | 5.05% |
| D-Glucose | 5.20% |
| Hydroxypropyl methyl cellulose | 1.30% |
| Water | 88.45% |

The coating was prepared by dissolution of the components in water. Upon drying, the coating (dry thickness ˜5-7 um) was imaged by a CO₂ laser (wavelength about 10.6 um; laser beam speed—1 m/sec; laser power 1-10 W). Dark yellow/brown marks were produced by the laser beam on the coating layer.

### EXAMPLE 2

Tables 24 illustrate additional illustrative coating layer formulations. The coating layers for each of these formulations have been prepared in a similar manner to the method described above. In addition, the coating layer has been imaged in a similar manner as that described above to produce dark yellow/brown marks on the coating layer.

TABLE 2

| | |
|---|---|
| L-Lysine | 5.0% |
| Potato Starch | 10% |
| Water | 85% |

TABLE 3

| | |
|---|---|
| L-Lysine | 5.0% |
| Arabinose | 5.0% |
| Water | 90% |

TABLE 4

| | |
|---|---|
| L-Lysine | 5.0% |
| Xylose | 5.0% |
| Water | 90% |

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. An edible object, comprising:
an edible coating layer disposed on the edible object, wherein the edible coating layer includes a sugar and at least one of amino acids, wherein upon irradiation by a laser source the sugar and amino acids react to form a brown color in the edible coating layer.

2. The edible object of claim 1, wherein at least one of the amino acids have a free amino acid group.

3. The edible object of claim 1, wherein the amino acid is lysine or glycine.

4. The edible object of claim 1, wherein the plurality of amino acids are in the form of a peptide.

5. The edible object of claim 4, wherein the peptide includes at least one lysine molecule.

6. The edible object of claim 1, wherein the sugar is selected from: pentose sugars, hexose sugars, disaccharides, polysugars, and combinations thereof.

7. The edible object of claim 1, wherein the sugar is a pentose sugar.

8. The edible object of claim 1, wherein the sugar is a hexose sugar.

9. The edible object of claim 1, further including: water-soluble polymeric binders selected from polysaccharides, polyvinyl pyrrolidone, soluble proteins, soluble cellulose derivatives, and combinations thereof.

10. The edible object of claim 1, wherein the edible object selected from a pill and a tablet

11. The edible object of claim 1, wherein the edible object is selected from: meat, poultry, fruit, and a baked good.

12. A method of forming a label on an edible object, the method comprising:
disposing a coating layer onto the edible object, wherein the coating layer includes an edible coating layer disposed on the edible object, wherein the edible coating layer includes a sugar and at least one of amino acids, wherein upon irradiation by a laser source the sugar and amino acids react to form a particular color in the edible coating layer.

13. The method of claim 12, further comprising:
exposing a portion of the coating layer to a radiation energy, wherein the radiation energy causes sugar and amino acids to react to form a brown color in the edible coating layer.

14. The method of claim 12, wherein the sugar is selected from: pentose sugars, hexose sugars, disaccharides, polysugars, and combinations thereof.

15. The method of claim 12, wherein at least one of the amino acids have a free amino acid group.

16. The method of claim 12, wherein the plurality of amino acids are in the form of a peptide.

17. The method of claim 12, wherein the particular color is brown.

18. The method of claim 12, wherein the particular color is other than brown.

19. The method of claim 12, wherein the edible object is a pill or tablet.

20. The method of claim 12, wherein the edible object is selected from meat, poultry, and fruit.
